(19) United States
(12) Patent Application Publication
(10) Pub. No.: US 2004/0244250 A1
(43) Pub. Date: Dec. 9, 2004

(54) Ceiling advertisement placard and method

(76) Inventor: Brett A. Febus, Hilliard, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/860,355

(22) Filed: Jun. 3, 2004

Related U.S. Application Data
(60) Provisional application No. 60/476,301, filed on Jun. 5, 2003.

(51) Int. Cl. G09F 7/22

(52) U.S. Cl. 40/617

(57) ABSTRACT

The invention is an apparatus and method of displaying indicia from a suspended ceiling. The method includes a first step of forming a substantially planar, sheet-like advertising placard. The placard has first and second opposing major surfaces with advertising indicia on at least the first major surface. A second step of the method includes arranging for the installation of the placard in a ceiling. The ceiling has a plurality of transverse, substantially horizontal support beams, which supports a plurality of polygonal, substantially planar ceiling panels. At least one replaceable panel, which is substantially the same size as the placard, is supported by a plurality of bordering support beams within the ceiling. The third step of installing the placard into the ceiling includes: (i) removing the replaceable panel from the bordering support beams, and (ii) positioning the placard adjacent to the bordering support beams with at least a part of the first major surface in abutment with the bordering support beams near the peripheral edges of the placard. Finally, viewing the first major surface of the placard from a reclined position beneath the placard.

### (b) CROSS-REFERENCES TO RELATED APPLICATIONS

This application claims the benefit of U.S. Provisional Application No. 60/476,301 filed Jun. 5, 2003.

### (c) STATEMENT REGARDING FEDERALLY-SPONSORED RESEARCH AND DEVELOPMENT

(Not Applicable)

### (d) REFERENCE TO AN APPENDIX

(Not Applicable)

### (e) BACKGROUND OF THE INVENTION

1. Field of the Invention

This invention relates generally to a suspended ceiling tile apparatus, and more specifically to a placard with indicia on at least one major surface placed in a suspended ceiling framework.

2. Description of the Related Art

It is well known to place ceiling tiles in spaces formed between a grid of transverse support frame members suspended beneath a roof or ceiling as shown in FIG. 1. The ceiling tiles 2 are ordinarily rectangular and are supported by the legs 4 of the frame members 6 which have an inverted-T shape in cross section. Such ceiling tile and support systems are well known and are used in various residential, commercial and industrial buildings.

It has been disclosed widely in the prior art that a ceiling tile can be replaced by a multi-faceted structure, which hangs beneath the plane of the normal ceiling tiles and the grid of support members to be visible to those observers who are walking beneath the suspended ceiling. It is also known to place various containers for holding lights or other desirably visible objects in or near a suspended ceiling in the place of a conventional ceiling tile.

It is an object and feature of the invention to provide a method and apparatus for displaying indicia from a ceiling to a viewer reclined beneath the ceiling.

### (f) BRIEF SUMMARY OF THE INVENTION

The invention is an apparatus and method of displaying indicia from a suspended ceiling. The method includes a first step of forming a substantially planar, sheet-like advertising placard. The placard has first and second opposing major surfaces with advertising indicia on at least the first major surface. A second step of the method includes arranging for the installation of the placard in a ceiling. The ceiling has a plurality of transverse, substantially horizontal support beams, which supports a plurality of polygonal, substantially planar ceiling panels. At least one replaceable panel, which is substantially the same size as the placard, is supported by a plurality of bordering support beams within the ceiling. The third step of installing the placard into the ceiling includes: (i) removing the replaceable panel from the bordering support beams, and (ii) positioning the placard adjacent to the bordering support beams with at least a part of the first major surface in abutment with the bordering support beams near the peripheral edges of the placard.

### (g) BRIEF DESCRIPTION OF THE SEVERAL VIEWS OF THE DRAWINGS

FIG. 1 is a side view in section illustrating a prior art ceiling tile system.

FIG. 2 is a view in perspective illustrating a preferred placard.

FIG. 3 is a view looking upwardly illustrating a ceiling with the preferred placard in a preferred location.

FIG. 4 is a side view in section illustrating a preferred location of a placard according to the invention.

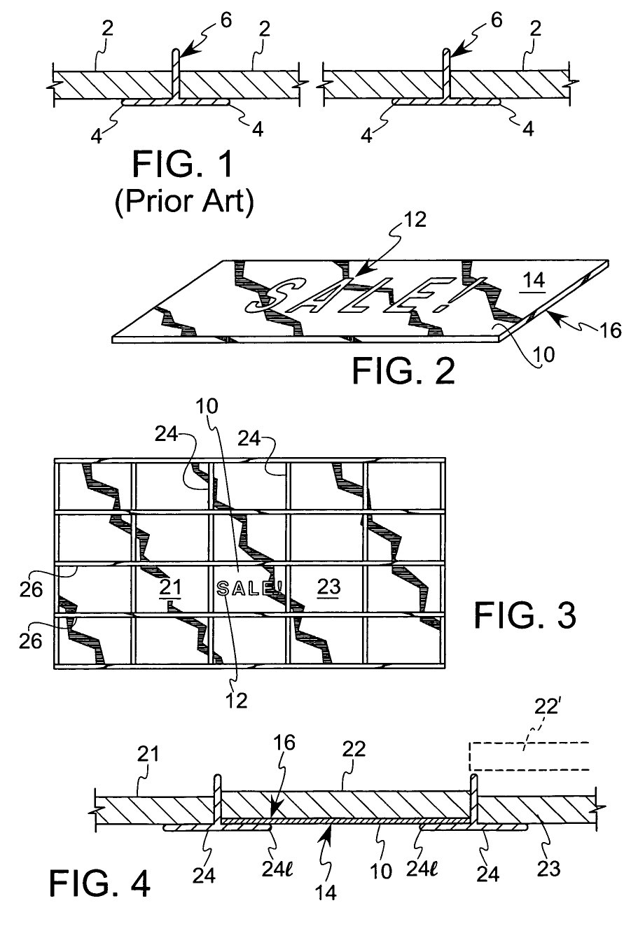

In describing the preferred embodiment of the invention, which is illustrated in the drawings, specific terminology will be resorted to for the sake of clarity. However, it is not intended that the invention be limited to the specific term so selected, and it is to be understood that each specific term includes all technical equivalents, which operate in a similar manner to accomplish a similar purpose.

### (h) DETAILED DESCRIPTION OF THE INVENTION

The preferred embodiment of the present invention is a preferably planar, sheet-like placard 10 having a generally rectangular shape with contemplated dimensions of approximately two feet wide by four feet long by one-quarter inch thick as shown in FIG. 2. Of course, size and shape are immaterial, as long as the placard is substantially the same length and width as the panel, such as a conventional ceiling tile, in the ceiling. For example, it is contemplated that the placard could be circular, triangular or any other shape a thin panel can be formed into.

The two major surfaces 14 and 16 of the placard 10 face in opposite directions, and at least one of the major surfaces bears indicia 12, which, for example, can be printed on, adhered to or otherwise fixed to the major surface 14. The placard 10 can be, for example, manufactured from foam core, cardboard, conventional ceiling tile material or any suitably rigid lightweight material that can bear indicia on at least one major surface thereof and be suspended as described below.

The placard 10 is mounted in a conventional suspended ceiling support frame 20 by first removing a conventional ceiling tile 22, which is referred to herein as a “replaceable” or “removable” tile because it can be removed from the frame support to permit placement of the placard 10 from its ordinary position as shown in FIG. 4. For example, the removable ceiling tile 22 can be pushed upwardly away from the floor of the room in which the ceiling tile is mounted and subsequently moved parallel to the remaining ceiling tile 23 to the side of its previous position. The new position of the ceiling tile 22 is shown in phantom by the reference numeral 22′. This permits the placard 10 to be extended upwardly through the hole that the removable ceiling tile 22 previously occupied and positioned in the frame where the removable ceiling tile 22 was previously positioned. This can be carried out, for example, by inserting a narrow end of the placard 10 through the opening until the entire placard is extended through the opening and then rotating the placard to align with the support members 24 and 26 upon which the placard will rest. The placard can then be displaced downwardly to seat its peripheral edges (and adjacent narrow region of the major surface 14 bearing the indicia) against the upwardly facing legs 241 of the support frame members 24 and 26 that previously surrounded the removable ceiling tile 22. The support frame 20 thus supports the placard 10 in the position in which the ceiling tile 22 was previously located. Subsequently, the ceiling tile 22 can be placed against the major surface 16 of the placard 10 that is opposite the major surface 14 bearing indicia 12. In this manner, the ceiling tile 22 essentially occupies its previous position but is displaced upwardly substantially the thickness of the placard 10 as shown in FIG. 4.

Once the placard 10 is positioned as described above, anyone looking upwardly at the placard from beneath it will be able to easily view the indicia 12 on the placard. In a preferred embodiment of the present invention the placard 10 is positioned directly above a reclining chair in a dentist's office, medical office, barbershop or other facility in which people are reclined facing upwardly toward the ceiling. Such a reclined position makes viewing of the indicia 12 on the placard 10 not only convenient, but also virtually inevitable. The term “reclined” is defined as the position in which the longitudinal axis of a person's body is in a position between horizontal and almost vertical, and the head is never the lowest point on the body. This can be spoken of in terms of the angle of the person's axis and the vertical axis, where a reclined person's axis is between 90 and 1 degree of vertical. The most likely reclined position would be between 30 and 60 degrees of vertical, and perhaps a typical reclined position is 45 degrees from vertical

In a preferred method of placing such placards, a person arranges with the owner or operator of the facility in which the placard will be installed to install the placard at a predetermined time and place. Either before or after the arrangements are made for the installation, placards have indicia fixed to them. The indicia can be anything including words, graphics or a combination. Subsequent to the printing and the arrangement for the installation, the placard, or a plurality of placards, are transported to the facility for the installation. Next a person (the installer) installs the placards directly above one or more reclining seating devices, such as dentist's chairs, and/or removes a previously existing placard. In a preferred embodiment of the method, the installer transports the placards to the facility and installs the placards. If the installer removes a previously existing placard, he or she can place the ceiling tile (which previously occupied the position of the removed placard) back to its original position. Alternatively, an old placard can be removed and replaced with a new placard bearing different or somehow more preferable indicia, and the ceiling tile is placed above the new placard as shown in FIG. 4.

It is generally understood that a method of placing the placards in the ceiling of a facility can be as simple as one party agreeing with another party to install the placards. However, it is preferred that a business method be employed to arrive at the most efficient and profitable manner of installing the placards. For example, the installer can agree to pay a fee to the owner of the facility that houses the ceiling in which the placards are to be placed. In another scenario, the owner of the facility pays the installer to install the placards. In a more complex scenario, the installer may be paid a fee by a third party for the installation work of installing placards in the owner's facility. The third party in that case may be an advertiser that has the placards printed itself. Of course, the installer may be the party that prints or contracts to print the placards for the third party and is paid a fee for the service of taking care of the printing and installation of the placards.

In the preferred method, a person forms a contract with owners or operators of the facilities in which the placards will eventually be placed and pays a fee for the exclusive right to place placards in those facilities. This can be done, for example, by an exclusive contract in which the lessee pays a fee to the lessor for the exclusive right to place placards in the ceiling of the lessor's facility. The lessee contracts or otherwise negotiates with an advertiser, or other third party, that pays or otherwise provides consideration to the lessee for the right to sublease space from the lessor. In one particular method, an advertiser pays the lessee a fee that includes the printing of placards and the management of installation of the placards at the lessor's facility. Of course, other methods could be implemented which are combinations or permutations of the above, as will become apparent to the person of ordinary skill.

While certain preferred embodiments of the present invention have been disclosed in detail, it is to be understood that various modifications may be adopted without departing from the spirit of the invention or scope of the following claims.

1. A method of displaying indicia comprising the steps of:
(a) forming a substantially planar, sheet-like advertising placard having first and second opposing major surfaces and advertising indicia on at least said first major surface;
(b) arranging for the installation of the placard in a ceiling having a plurality of transverse, substantially horizontal support beams supporting a plurality of polygonal, substantially planar ceiling panels, wherein at least a replaceable panel that is supported by a plurality of bordering support beams is substantially the same size as said placard; and
(c) installing the placard in the ceiling, including:
(i) removing said replaceable panel from the bordering support beams; and
(ii) positioning said placard adjacent to said bordering support beams with at least a part of said first major surface in abutment with said bordering support beams near peripheral edges of the placard.

2. The method in accordance with claim 1, further comprising the step of viewing the first major surface of the placard from a reclined position beneath the placard.

3. The method in accordance with claim 2, further comprising the step of positioning said replaceable panel on the second major surface of the placard in a substantially parallel relationship.

4. The method in accordance with claim 1, wherein said replaceable panel and the placard are translucent and are positioned directly beneath a light fixture.

5. An apparatus comprising: a substantially planar, sheet-like advertising placard having first and second opposing major surfaces and advertising indicia on at least said first major surface, said placard being in a ceiling having a plurality of transverse, substantially horizontal support beams supporting a plurality of polygonal, substantially planar ceiling panels, wherein at least a replaceable panel is substantially the same size as the placard.

6. The apparatus in accordance with claim 5, wherein the indicia on the first major surface of the placard are visible from a reclined position beneath the placard.

7. The apparatus in accordance with claim 6, wherein the placard is translucent and is positioned beneath a light fixture.

8. The apparatus in accordance with claim 5, wherein the replaceable panel is positioned on the second major surface of the placard in a substantially parallel relationship.

9. The apparatus in accordance with claim 8, wherein the replaceable panel and the placard are translucent and are positioned directly beneath a light fixture.

10. The apparatus in accordance with claim 5, wherein the panel is parallel to and co-planar with the ceiling.

11. The apparatus in accordance with claim 6, further comprising a reclinable human seating surface beneath the parallel ceiling.

12. The apparatus in accordance with claim 11, further comprising a human reclined in the reclinable human seating surface beneath the parallel ceiling.
